(19) United States
(12) Patent Application Publication
(10) Pub. No.: US 2002/0169957 A1
(43) Pub. Date: Nov. 14, 2002

(54) GUI administration of discretionary or mandatory security policies

(76) Inventors: Douglas LaVell Hale, Orem, UT (US); Kyle Bryan Seegmiller, Salt Lake City, UT (US); Douglas Kelly Thompson, Herber City, UT (US)

Correspondence Address: SAWYER LAW GROUP LLP, P.O. Box 51418, Palo Alto, CA, 94303, US

(21) Appl. No.: 09/851,660

(22) Filed: May 8, 2001

(51) Int. Cl. H04L 9/00

(52) U.S. Cl. 713/166

(57) ABSTRACT

A method and system for graphical administration of security policies in a computer system includes: displaying a graphical representation of at least one subject; displaying a graphical representation of at least one object; displaying a graphical representation of a security policy; and dragging and dropping the graphical representation of the at least one subject and the graphical representation of the at least one object into the graphical representation of the security policy, where the dragging and dropping grants the at least one subject access to the at least one object under the security policy. Graphical representations of subjects, objects, and policies are used in a graphical user interface (GUI). A user can administrate the subjects and objects by performing a “drag and drop” of their graphical representations into the graphical representation of a policy. In this manner, users need not have extraordinary training or skills to administrate security policies.

### FIELD OF THE INVENTION

The present invention relates to computer systems, and security in computer systems.

### BACKGROUND OF THE INVENTION

Security in access to data in computer systems is a consistent concern in the industry. Computer security comprises a set of conditions under which subjects can access objects. As used in this specification, “subjects” are people or users and “objects” are data. The set of conditions is called a “policy”. A policy describes which operations can be performed by which subjects on which objects.

There are two types of operations: read and write. If a subject can read an object, then the subject has “read rights” to the object. If a subject can write an object, then the subject has “write rights” to the object. If the subject has read and/or write rights to an object, then the subject has “rights” to the object.

There are two types of policies: discretionary and mandatory. A discretionary policy is a policy in which a security administrator determines a subject's rights to objects at the administrator's discretion. A mandatory policy is a policy in which an object is given a sensitivity label and a subject is given a trust level. If the subject's trust level dominates, i.e., is greater than or equal to, the sensitivity level of the object, then the subject has rights to the object. Otherwise, the subject has no rights to the object.

There are typically two sets of sensitivity levels on objects: a read sensitivity level and a write sensitivity level. These sensitivity levels are called “secrecy level” and “integrity level”, respectively. Subjects also have corresponding trust levels. A subject has read rights if the subject's secrecy level dominates the object's secrecy level. Likewise, a subject has write rights if the subject's integrity level dominates the object's integrity level.

A mandatory policy also includes a category. The category is used to further refine access. The object's category must be included in the set of categories in the subject's classification, along with the subject's secrecy and integrity levels dominating those of the object, if the subject is to have rights to the object. Categories and levels may have text names for convenience of reference.

Conventional computer security systems provide administrative tools that allow system security administrators to view and alter discretionary and mandatory security policies. However, these tools require that the security administrators have extraordinary training and skills in order to properly use them. Thus, the tools are not typically used by general system users. This increases the overhead of the computer system. Also, if the system is mobile, for example, a laptop computer, then it may be impractical for the general user to obtain maintenance of the security system.

Accordingly, there exists a need for a method and system for graphical administration of security policies in a computer system. The method and system should not require users to have extraordinary training and skills. The present invention addresses such a need.

### SUMMARY OF THE INVENTION

A method and system for graphical administration of security policies in a computer system includes: displaying a graphical representation of at least one subject; displaying a graphical representation of at least one object; displaying a graphical representation of a security policy; and dragging and dropping the graphical representation of the at least one subject and the graphical representation of the at least one object into the graphical representation of the security policy, where the dragging and dropping grants the at least one subject access to the at least one object under the security policy. Graphical representations of subjects, objects, and policies are used in a graphical user interface (GUI). A user can administrate the subjects and objects by performing a “drag and drop” of their graphical representations into the graphical representation of a policy. In this manner, users need not have extraordinary training or skills to administrate security policies.

### BRIEF DESCRIPTION OF THE FIGURES

FIG. 1 is a flowchart illustrating a preferred embodiment of a method for graphical administration of security policies in a computer system in accordance with the present invention.

FIG. 2 illustrates a first preferred embodiment of a GUI provided by the method for graphical administration of security policies in a computer system in accordance with the present invention.

FIG. 3 illustrates a second preferred embodiment of a GUI provided by the method for graphical administration of security policies in a computer system in accordance with the present invention.

FIG. 4 illustrates a third preferred embodiment of a GUI provided by the method for graphical administration of security policies in a computer system in accordance with the present invention.

FIG. 5 illustrates a fourth preferred embodiment of a GUI provided by the method for graphical administration of security policies in a computer system in accordance with the present invention.

### DETAILED DESCRIPTION

The present invention provides a method and system for graphical administration of security policies in a computer system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method and system in accordance with the present invention for graphical administration of security policies uses a graphical user interface (GUI). “Graphical representations” (i.e., any graphical elements such as an image, icon, etc.) of subjects, objects, and policies are used in the GUI. A user can administrate the subjects and objects by performing a “drag and drop” of their graphical representations into the graphical representation of a policy. The dragging and dropping of graphical representations of a subject and an object into the same graphical representation of the policy signifies that the subject is being granted access to the object under the policy.

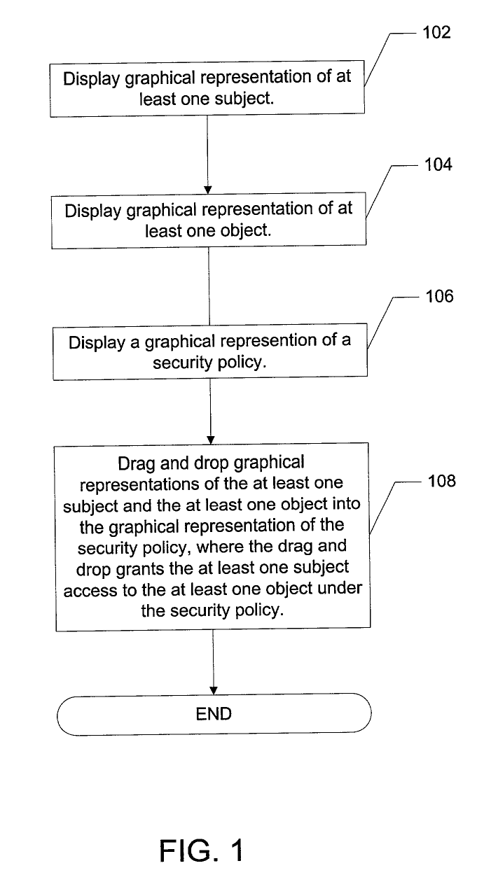

To more particularly describe the features of the present invention, please refer to FIGS. 1 through 5 in conjunction with the discussion below.

FIG. 1 is a flowchart illustrating a preferred embodiment of a method for graphical administration of security policies in a computer system in accordance with the present invention. First, a graphical representation of at least one subject is displayed, via step 102. A graphical representation of at least one object is also displayed, via step 104, as well as a graphical representation of a security policy, via step 106. Then, the at least one subject and the at least one object are dragged and dropped into the graphical representation of the security policy, where the drag and drop grants the at least one subject access to the at least one object under the security policy, via step 108.

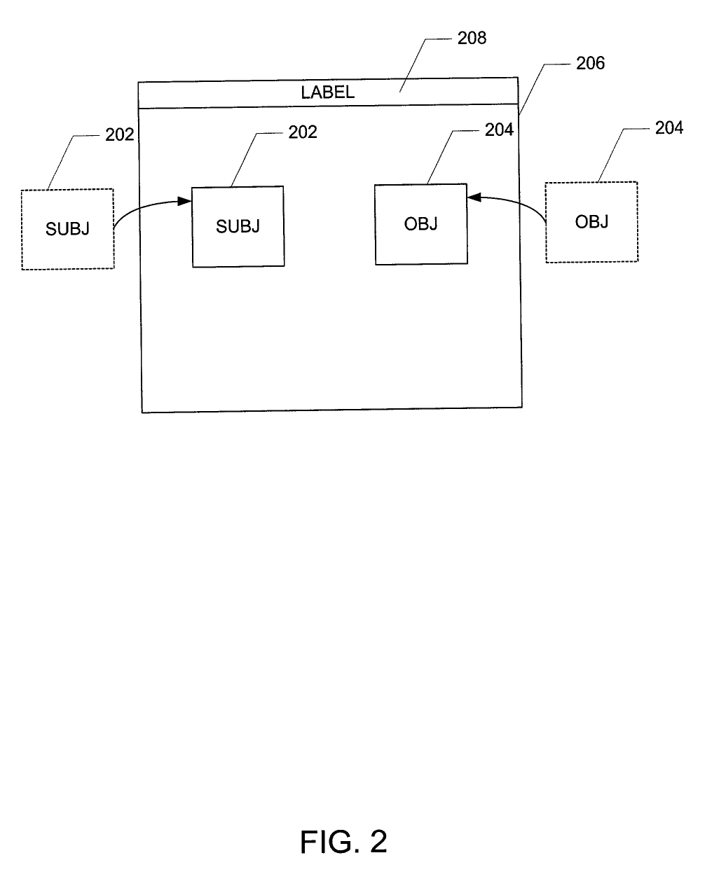

FIG. 2 illustrates a first preferred embodiment of a GUI provided by the method for graphical administration of security policies in a computer system in accordance with the present invention. The first preferred embodiment of the GUI displays a graphical representation of a subject 202, via step 102, and a graphical representation of an object 204, via step 104. The first GUI also displays a window 206 as the graphical representation of a security policy, via step 106. In this embodiment, a label 208 is included in the window 206 to indicate the security policy in which the window 206 represents. A user of the first GUI may then drag and drop the graphical representation of the subject 202 and the graphical representation of the object 204 into the window 206, via step 108. By dragging and dropping the graphical representations of the subject 202 and object 204 into the window 206, the user grants the subject access to the object under the security policy represented by the window 206.

For example, assume that a discretionary security policy is being administered. The window 206 represents a grouping of rights. Dragging and dropping the graphical representation of the object 204 into the window 206 indicates which that the object represented is being administered. Dragging and dropping the graphical representation of the subject 202 into the window 206 indicates that the subject represented is being granted rights to the object represented in the window 206. The rights could be either read rights, write rights, or both, depending on the particular security policy.

For another example, assume that a mandatory security policy is being administered. The window 206 represents a sensitivity level and category for objects, and a trust level and classification for subjects. Dragging and dropping the graphical representation of the object 204 into the window 206 signifies the assigning of the sensitivity label and the category to the object represented. Dragging and dropping the graphical representation of the subject 202 into the window 206 signifies the assigning of the trust level and the classification to the subject represented.

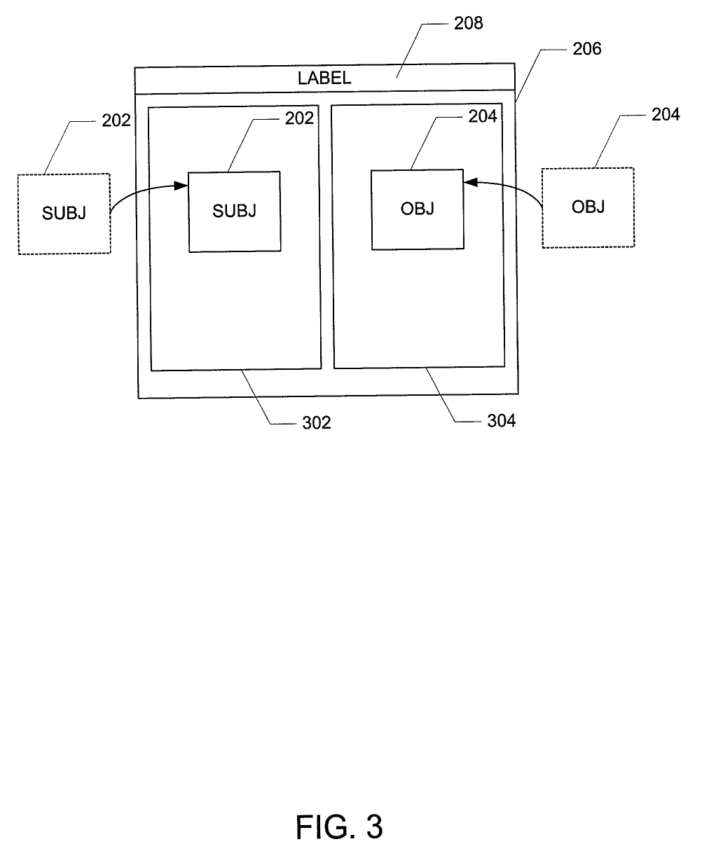

FIG. 3 illustrates a second preferred embodiment of a GUI provided by the method for graphical administration of security policies in a computer system in accordance with the present invention. The second GUI comprises the same elements as the first GUI, illustrated in FIG. 2, except the graphical representations of the subject 202 and object 204 are segregated. For example, the graphical representation of the subject 202 is provided in a first sub-window 302, while the graphical representation of the object 204 is provided in a second sub-window 304. The sub-windows 302 and 304 organizes the graphical representations in the window 206. The placement, shape, and size of the sub-windows 302 and 304 may vary.

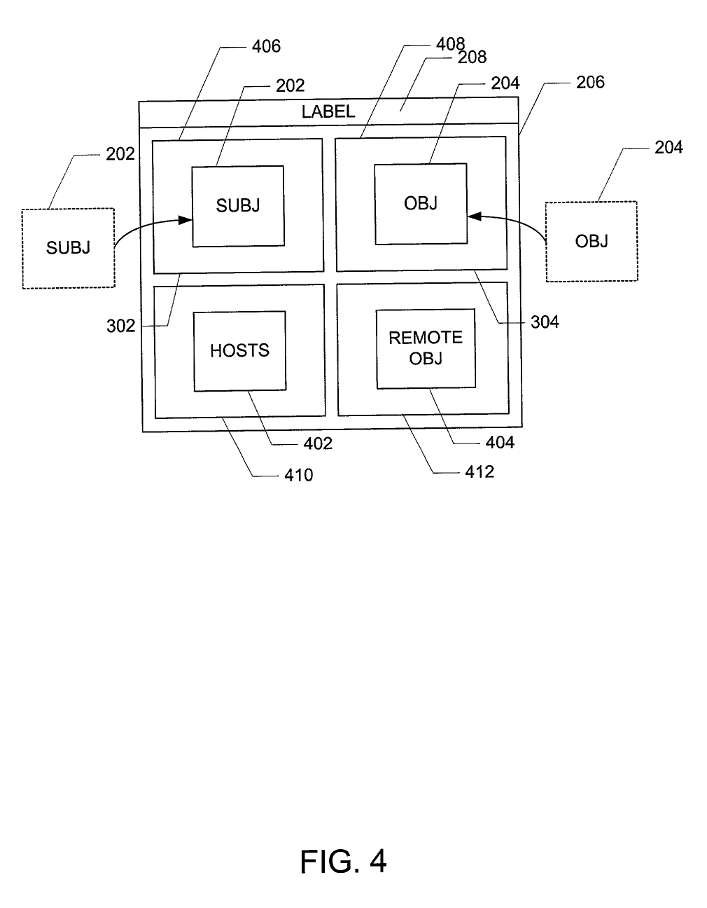

FIG. 4 illustrates a third preferred embodiment of a GUI provided by the method for graphical administration of security policies in a computer system in accordance with the present invention. The third GUI comprises the same elements as the second GUI, illustrated in FIG. 3, except the third GUI also comprises graphical representations of hosts 402 and remote objects 404. These indicate that the hosts, represented by graphical representation 402, have granted to the user access to the remote objects, represented by graphical representation 404, under the security policy represented by the window 206. Optionally, the graphical representations of the hosts 402 and the remote objects 404 may be displayed in sub-windows 410 and 412, respectively. The placement, shape, and size of the sub-windows 302, 304, 410, and 412 may vary.

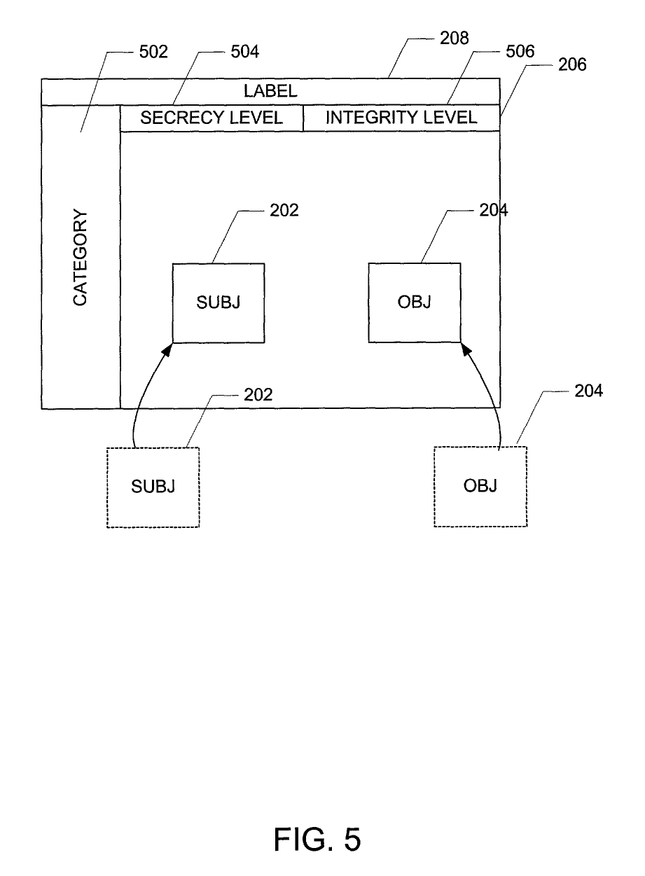

FIG. 5 illustrates a fourth preferred embodiment of a GUI provided by the method for graphical administration of security policies in a computer system in accordance with the present invention. The fourth GUI comprises the same elements as the first GUI, illustrated in FIG. 2, except the fourth GUI also comprises additional labels 502-506 which provide information concerning the security policy represented by the window 206. For example, the fourth GUI may comprise labels 502 and 504 concerning the category and secrecy level, respectively, of objects with graphical representations in the window 206. Also, the fourth GUI may comprise a label 506 concerning the integrity level and classification of the subjects with graphical representation in the window 206. The placement, shape, and size of the labels may vary. Other labels are also possible.

Although the present invention has been described with the particular GUI's and graphical representations above, one of ordinary skill in the art will understand that other GUI's and graphical representations are possible without departing from the spirit and scope of the present invention.

Additional features may be added to the GUI to assist the user in administering security policies. One feature is to provide tools which allow the user to view and/or modify attributes of particular subjects and objects represented in the window 206. For example, the user may double-click on the graphical representation of the subject 202 to display a property page or a dialogue. The property page or dialogue displays the attributes of the subject and allows the user to modify them. Another feature is to provide tools for creating and deleting graphical representations of objects or subjects. Other tools are possible.

A method and system for graphical administration of security policies in a computer system has been disclosed. The method and system uses a graphical user interface (GUI). Graphical representations of subjects, objects, and policies are used in the GUI. A user can administrate the subjects and objects by performing a “drag and drop” of their graphical representations into the graphical representation of a policy. The dragging and dropping of graphical representations of a subject and an object into the same graphical representation of the policy signifies that the subject is being granted access to the object under the policy. In this manner, users need not have extraordinary training or skills to administrate security policies.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for administration of security policies in a computer system, comprising the steps of:
(a) displaying a graphical representation of at least one subject;
(b) displaying a graphical representation of at least one object;
(c) displaying a graphical representation of a security policy; and
(d) dragging and dropping the graphical representation of the at least one subject and the graphical representation of the at least one object into the graphical representation of the security policy, wherein the dragging and dropping grants the at least one subject access to the at least one object under the security policy.

2. The method of claim 1, wherein the at least one subject is a user.

3. The method of claim 1, wherein the at least one object is data.

4. The method of claim 1, wherein the dragging and dropping grants the at least one subject read and/or write rights to the at least one object.

5. The method of claim 1, wherein the dragging and dropping assigns a sensitivity level and a category to the at least one object, wherein the dragging and dropping assigns a trust level and a classification to the at least one subject.

6. The method of claim 1, wherein the graphical representation of the at least one subject or the at least one object comprises an image or an icon.

7. The method of claim 1, wherein the graphical representation of the security policy comprises at least one window.

8. The method of claim 7, wherein the graphical representation of the security policy further comprises at least one label.

9. The method of claim 1, further comprising:
(e) providing a tool for viewing attributes of the at least one subject or the at least one object.

10. The method of claim 1, further comprising:
(e) providing a tool for creating or deleting the least one subject or the at least one object.

11. A computer readable medium with program instructions for administration of security policies in a computer system, comprising the instructions for:
(a) displaying a graphical representation of at least one subject;
(b) displaying a graphical representation of at least one object;
(c) displaying a graphical representation of a security policy; and
(d) dragging and dropping the graphical representation of the at least one subject and the graphical representation of the at least one object into the graphical representation of the security policy, wherein the dragging and dropping grants the at least one subject access to the at least one object under the security policy.

12. The medium of claim 11, wherein the at least one subject is a user.

13. The medium of claim 11, wherein the at least one object is data.

14. The medium of claim 11, wherein the dragging and dropping grants the at least one subject read and/or write rights to the at least one object.

15. The medium of claim 11, wherein the dragging and dropping assigns a sensitivity level and a category to the at least one object, wherein the dragging and dropping assigns a trust level and a classification to the at least one subject.

16. The medium of claim 11, wherein the graphical representation of the at least one subject or the at least one object comprises an image or an icon.

17. The medium of claim 11, wherein the graphical representation of the security policy comprises at least one window.

18. The medium of claim 17, wherein the graphical representation of the security policy further comprises at least one label.

19. The medium of claim 11, further comprising instructions for:
(e) providing a tool for viewing attributes of the at least one subject or the at least one object.

20. The medium of claim 11, further comprising instructions for:
(e) providing a tool for creating or deleting the least one subject or the at least one object.

21. A system, comprising:
a graphical representation of at least one subject;
a graphical representation of at least one object; and
a graphical representation of a security policy, wherein the graphical representation of the at least one subject and the graphical representation of the at least one object may be dragged and dropped into the graphical representation of the security policy, wherein the dragging and dropping grants the at least one subject access to the at least one object under the security policy.

22. The system of claim 21, wherein the at least one subject is a user.

23. The system of claim 21, wherein the at least one object is data.

24. The system of claim 21, wherein the dragging and dropping grants the at least one subject read and/or write rights to the at least one object.

25. The system of claim 21, wherein the dragging and dropping assigns a sensitivity level and a category to the at least one object, wherein the dragging and dropping assigns a trust level and a classification to the at least one subject.

26. The system of claim 21, wherein the graphical representation of the at least one subject or the at least one object comprises an image or an icon.

27. The system of claim 21, wherein the graphical representation of the security policy comprises at least one window.

28. The system of claim 27, wherein the graphical representation of the security policy further comprises at least one label.

29. The system of claim 21, further comprising a tool for viewing attributes of the at least one subject or the at least one object.

30. The system of claim 21, further comprising a tool for creating or deleting the least one subject or the at least one object.
